(19) United States
(12) Patent Application Publication
(10) Pub. No.: US 2007/0112725 A1
(43) Pub. Date: May 17, 2007

(54) METHODS AND SYSTEMS FOR ACCESSING DIGITAL IMAGE FILES

(75) Inventors: Jing Shun Lin, Yilan County (TW); Chao Lien Tsai, Taipei City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/560,311

(22) Filed: Nov. 15, 2006

(30) Foreign Application Priority Data
Nov. 17, 2005 (TW) TW94140417

(51) Int. Cl. G06F 17/30

(52) U.S. Cl. 707/2

(57) ABSTRACT

A method for accessing digital image files. The method is applied in a digital image capture device store at least one image file. At least one first image is chosen from the at least one image file. A file level code is set in the at least one first image, and the file level code indicates access authority of the at least one first image file. When the at least one first image is accessed, a second image file is chosen from the at least one first image file. The file level code of the second image file is read, and then the second image file is processed according to the file level code.

### BACKGROUND OF THE INVENTION

1. Field of the Invention

The invention relates to a method for accessing files, and more particularly to a method for accessing digital image files, applied in a digital image capture device.

2. Description of the Related Art

Image capture devices, such as digital cameras, are vary popular. Images captured by a digital camera are saved as digital image files to a built-in memory medium or a memory card.

The digital image files usually conform to a specific file format, such as exchangeable image file format for digital still camera (EXIF). EXIF is formulated for digital still images. The EXIF format comprises a file header for storing additional information about the file and a user comment field for storing comment information provided by users. The user comment field is different from general image description tags. The user comment field is not limited by character codes, thus, any information, such as the manufacturer of the digital camera can be saved.

Digital cameras do not typically comprises user access control, this means any can access images stored thereon. For example, a person A is the owner of a digital camera, and the person A captures a plurality of images by the digital camera and stores in the digital camera as digital image files. When a person B borrows the digital camera from the person A, the person B can access or process the digital image files captured by the person A if any one has equal authority to access the files stored in the digital camera.

In current accessing maimers of digital image files in digital cameras, users may remissly cancel the digital image files when they operate the digital cameras. Therefore, the security of digital image files in digital cameras is important.

### BRIEF SUMMARY OF THE INVENTION

An exemplary embodiment of a method for accessing digital image files display panel is applied in a digital image capture device, such as a digital camera. The digital image capture device stores a plurality of image files. The image files are captured by the digital image capture device and then directly stored in the digital image capture device, or are transmitted by a storage medium to the digital image capture device and then stored in the digital image capture device.

First, at least one first image file conforming to an EXIF format is chosen from the plurality of image files and. A file level code is then set in the at least one first image file. The setting of the file level codes can be implemented through an input interface, such as a button or keyboard. The file level codes indicate the access authority of the at least one first image file. The at least one first image file comprises a comment field to store the setting of the file level codes.

Then, a second image file is chosen from the at least one first image file, and the file level code of the second image file is then read. The second image file is processed according to the read file level code. Processing the second image file comprises determining user authority or determining file processing manners according to the read file level code.

The file processing manners can comprise no displaying, no editing, no displaying small pictures, or playing recorded files. In other words, when a user desires to access the image files, the user authority and the file processing manners can be determined through the setting of the file level codes.

An exemplary embodiment of a storage medium is provided. The storage medium stores a computer program providing the described method for accessing digital image files, comprising using a computer to perform the described steps.

An exemplary embodiment of a system for accessing digital image files is provided. The system is applied in a digital image capture device, such as a digital camera. The digital image capture device comprises a storage unit 300 to store a plurality of image files. The image files are captured by the digital image capture device and then directly stored in the digital image capture device. The system comprises a first choosing module, a setting module, a second choosing module, reading module, and a processing module.

The first choosing module chooses at least one first image file from the plurality of image files. The at least one first image files conforms an EXIF format, such as EXIF 2.2. The setting module sets a file level code in the at least one first image file, and the file level codes indicate access authority of the at least one first image file. The system further comprises an input interface to implement the setting of the file level codes. The at least one first image file comprises a comment field to store the setting of the file level codes.

The second choosing module chooses a second image file from the at least one first image file. The reading module reads the file level code of the second image file. The processing module processes the second image file according to the read file level code. The processing module determines user authority and the file processing maimers according to the read file level code.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a flow chart of an embodiment of a method for accessing digital image files;

FIG. 2 depicts an embodiment of a storage medium;

FIG. 3 is a function block diagram of an embodiment of a system for accessing digital image files; and

FIGS. 4a and 4b depicts an embodiment of a method for accessing digital image files.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

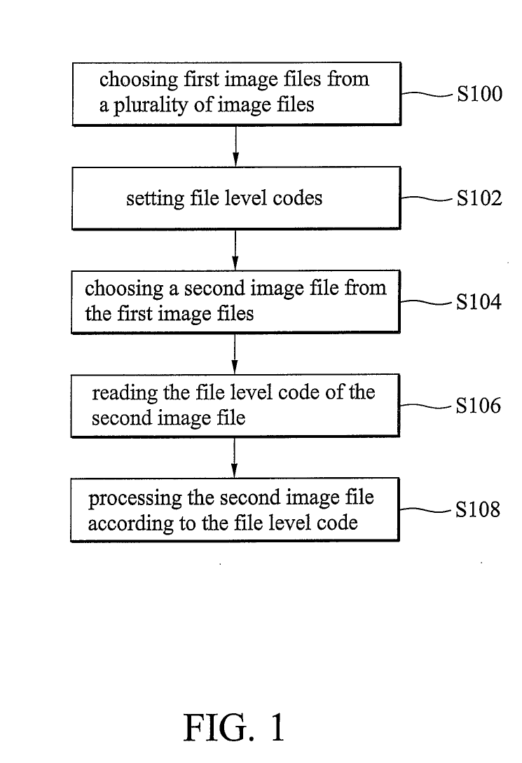

Methods for accessing digital image files are provided. FIG. 1 is a flow chart of a method for accessing digital image files, and the method is applied in a digital image capture device, such as a digital camera. The digital image capture device stores a plurality of image files. The image files are captured by the digital image capture device and then directly stored in the digital image capture device, or are transmitted by a storage medium to the digital image capture device and then stored in the digital image capture device.

First, at least one first image file is chosen from the plurality of image files (step S100) and conforms an EXIF format. In this embodiment, a plurality of first image files are given as an example. A file level code is then set in each first image file (step S102). The setting of the file level codes can be implemented through an input interface, and the file level codes indicate the access authority of the first image files. Each first image file comprises a comment field to store the setting of the file level codes.

Then, a second image file is chosen from the plurality of first image files (step S104), and the file level code of the second image file is then read (step S106). The second image file is processed according to the read file level code (step S108). Processing the second image file comprises determining user authority or determining file processing manners according to the read file level code.

The file processing manners can comprise no displaying, no editing, no displaying small pictures, or playing recording files. In other words, when a user desires to access the image files, the user authority and the file processing manners can be determined through the setting of the file level codes.

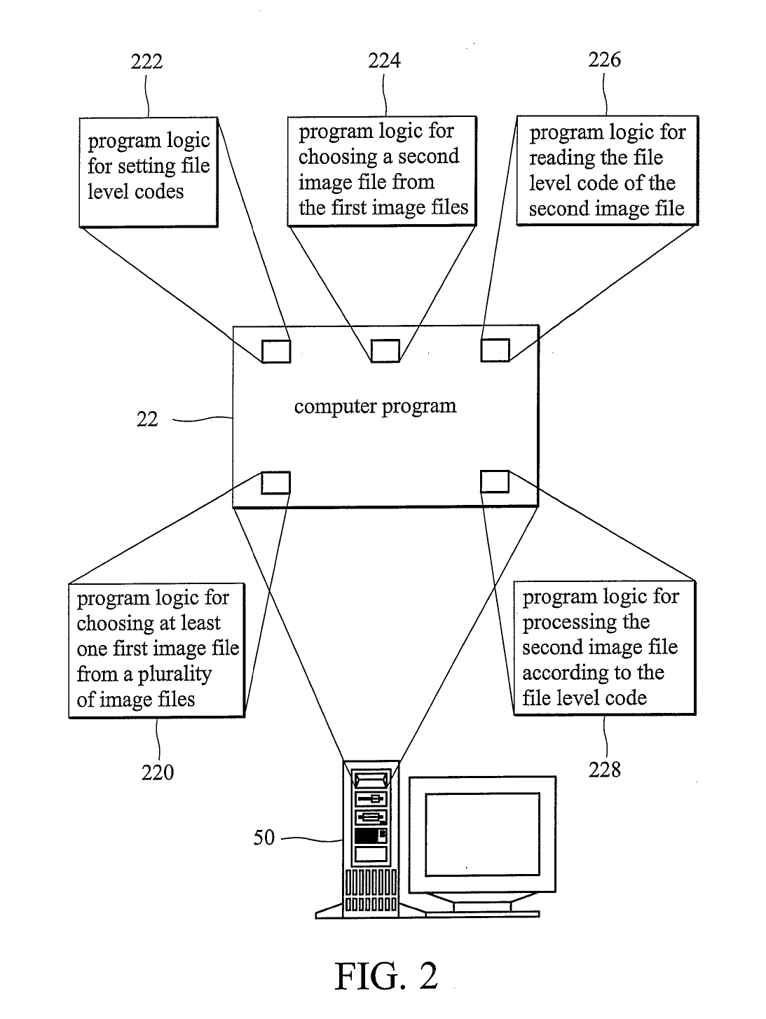

FIG. 2 depicts an embodiment of a storage medium. Referring to FIG. 2, a storage medium 20 storing a computer program 22 is provided. The computer program 22 is loaded on a computer system, and the computer system then performs the described method for accessing digital image files. The computer program 20 comprises a program logic 220 for choosing at least one first image file from a plurality of image files. In this embodiment, a plurality of first image files are given as an example. The computer program 20 further comprises a program logic 222 for setting file level codes, a program logic 224 for choosing a second image file from the first image files, a program logic 226 for reading the file level code of the second image file, and a program logic 228 for processing the second image file according to the file level code.

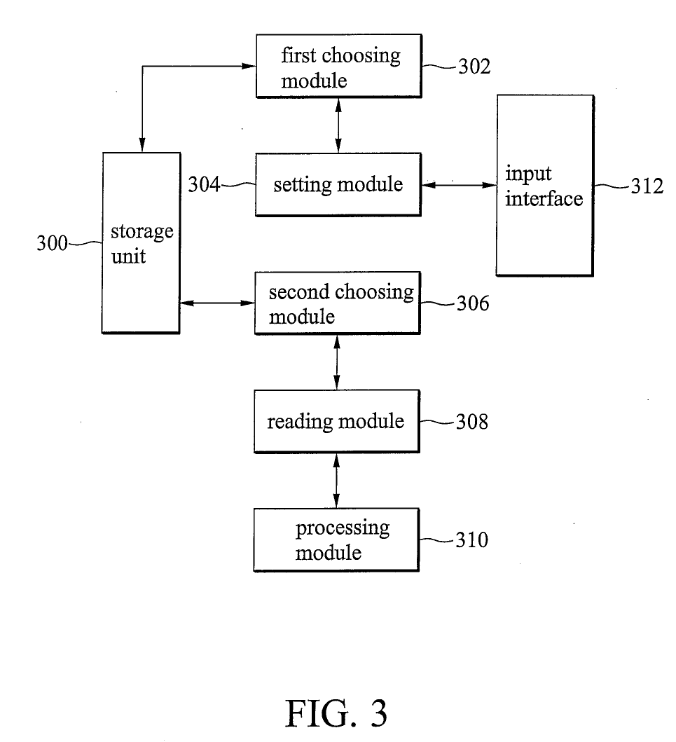

FIG. 3 is a function block diagram of an embodiment of a system for accessing digital image files. The system is applied in a digital image capture device, such as a digital camera. The digital image capture device comprises a storage unit 300 to store a plurality of image files. The image files are captured by the digital image capture device and then directly stored in the digital image capture device. The system comprises a first choosing module 302, a setting module 304, a second choosing module 306, reading module 308, and a processing module 310.

The first choosing module 302 chooses at least one first image file from the plurality of image files. In this embodiment, a plurality of first image files are given as an example. The first image files conform to an EXIF format. The setting module 304 sets a file level code in each first image file, and the file level codes indicate access authority of the first image files. The system further comprises an input interface 312 to implement the setting of the file level codes. Each first image file comprises a comment field to store the setting of the file level codes.

The second choosing module 306 chooses a second image file from the first image files. The reading module 308 reads the file level code of the second image file. The processing module 310 processes the second image file according to the read file level code. In other words, the processing module 310 determines user authority according to the read file level code.

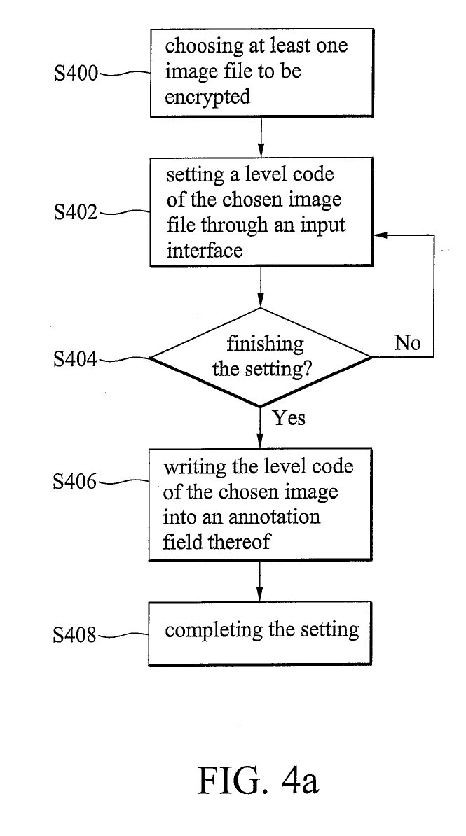

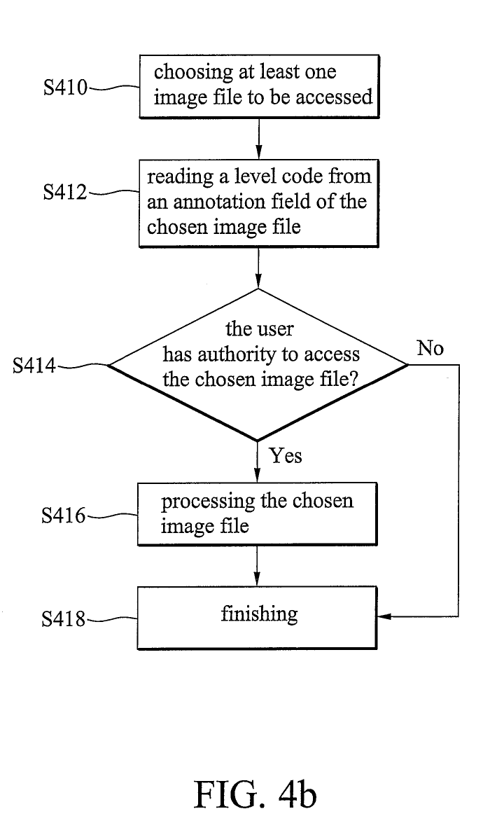

FIGS. 4a and 4b depicts an embodiment of a method for accessing digital image files, and the method is applied in a digital camera. The digital camera stores a plurality of image files by a storage unit, such as a memory card. The image files are captured by the digital camera and then directly stored in the digital camera, or are transmitted by a storage medium to the digital camera and then stored in the digital camera.

When the owner of the digital camera desires to apply a safety setting to the image files stored in the digital camera, at least one image file from the image files to be encrypted is chosen (step S400). A level code of the chosen image file is set through an input interface (step S402). Then, it is determined whether the setting of the chosen image file is finished (step S404). If the setting of the chosen image file is finished, the level code set in the step 402 is written into a comment field thereof (step S406), and then the setting is completed (step S408).

When a user, who is not the owner, chooses at least one image file to be accessed (step S410), the level code is read from the comment field of the chosen image file (step S412). It is then determined whether the user has authority to access the chosen image file or not (step S414). When the user has the authority, the chosen image file is correspondingly processed according to the level code (step S416), such as no displaying, no editing, no displaying small pictures, or playing recorded files. The processing of the chosen image file is then finished (step S418). When the user does not have authority to access the chosen image, the processing of the chosen image file is immediately finished (step S418).

As described above, the system and method for accessing digital image files can manage files of a digital image capture device and improve the security of using files stored in the digital image capture device.

Methods and systems of the present invention, or certain aspects or portions of embodiments thereof, may take the form of program code (i.e., instructions) embodied in media, such as floppy diskettes, CD-ROMS, hard drives, firmware, or any other storage medium, wherein. When the program code is loaded into and executed by a machine, such as a computer, the machine becomes an apparatus for practicing and embodiment of the invention. The method and system of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the invention. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for accessing digital image files, applied in a digital image capture device store at least one image file, and comprising:
choosing at least one first image file from the at least one image file; and
setting a file level code in the at least one first image, wherein the file level code indicates access authority of the at least one first image file.

2. The method as claimed in claim 1 further comprising:
choosing a second image file from the at least one first image file;
reading the file level code of the second image file; and
processing the second image file according to the file level code.

3. The method as claimed in claim 2, wherein the step of processing the second image file comprises determining user authority according to the file level code.

4. The method as claimed in claim 2, wherein the step of processing the second image file comprises determining a file processing manner according to the file level code.

5. The method as claimed in claim 1, wherein the setting of the file level code is implemented through an input interface.

6. The method as claimed in claim 1, wherein the at least one first image level comprises a comment field storing the setting of the file level code.

7. The method as claimed in claim 1, wherein the at least one first image file conforms to an EXIF format.

8. The method as claimed in claim 1, wherein the at least one image file is captured by the digital image capture device.

9. The method as claimed in claim 1, wherein the digital image capture device is a digital camera.

10. A storage medium for storing a computer program providing a method for accessing digital image files, comprising using a computer to perform the steps claimed in claim 1.

11. A system for accessing digital image files, applied in a digital image capture device comprising a storage unit for storing at least one image file, and the system comprising:
a first choosing module coupled to the storage unit and choosing at least one first image file from the at least one image file; and
a setting module coupled to the first choosing module and setting a file level code in the at least one first image file, wherein the file level code indicates access authority of the at least one first image file.

12. The system as claimed in claim 11 further comprising:
a second choosing module coupled to the storage unit and choosing a second image file from the at least one first image file;
a reading module coupled to the second choosing module and reading the file level code of the second image file; and
a processing module coupled to the reading module and processing the second image file according to the file level code.

13. The system as claimed in claim 12, wherein the processing module determines user authority according to the file level code.

14. The system as claimed in claim 12, wherein the processing module determines a file processing manner according to the file level code.

15. The system as claimed in claim 11 further comprises an input interface coupled to the setting module and implementing the setting of the file level code.

16. The system as claimed in claim 11, wherein the at least one first image level comprises a comment field storing the setting of the file level code.

17. The system as claimed in claim 11, wherein the at least one first image file conforms to an EXIF format.

18. The system as claimed in claim 11, wherein the at least one image file is captured by the digital image capture device.

19. The system as claimed in claim 11, wherein the digital image capture device is a digital camera.
